(19) United States
(12) Patent Application Publication
(10) Pub. No.: US 2021/0287858 A1
(43) Pub. Date: Sep. 16, 2021

(54) POWER SOURCE FOR A VOLTAGE REGULATION DEVICE

(71) Applicant: Eaton Intelligent Power Limited, Dublin (IE)

(72) Inventors: Jonathan Michael Schaar, Greenfield, WI (US); Tiefu Zhao, Charlotte, NC (US); Yafeng Wang, Charlotte, NC (US)

(21) Appl. No.: 17/179,788

(22) Filed: Feb. 19, 2021

Related U.S. Application Data
(60) Provisional application No. 62/988,550, filed on Mar. 12, 2020.

(51) Int. Cl. H01H 9/00; G05F 1/66; G05B 19/05

(52) U.S. Cl. CPC H01H 9/0027; H01H 9/0016; G05F 1/66; G05B 2219/15097; H01H 9/0011; H01H 2009/0061; G05B 19/058

(57) ABSTRACT

A voltage regulation device includes: a plurality of taps; a first electrical contact configured to connect to one of the plurality of taps; a second electrical contact configured to connect to one of the plurality of taps; and a network electrically connected to the first electrical contact and to the second electrical contact. The network is configured to control a voltage differential between the first electrical contact and the second electrical contact or an amount of current that flows in the first electrical contact and the second electrical contact.

### CROSS-REFERENCE TO RELATED APPLICATION

This application claims the benefit of U.S. Provisional Application No. 62/988,550, filed on Mar. 12, 2020 and titled POWER SOURCE FOR A VOLTAGE REGULATION DEVICE, which is incorporated herein by reference in its entirety.

### TECHNICAL FIELD

This disclosure relates to a power source for a voltage regulation device.

### BACKGROUND

Voltage regulators are used to monitor and control a voltage level in an electrical power distribution network. A voltage regulator includes a main winding and an electromagnetic circuit that delivers current from the main winding to an electric load. The electromagnetic circuit includes electrical contacts, and the main winding includes a plurality of taps. The output voltage of the voltage regulator is determined by which of the plurality of taps are in contact with the electrical contacts.

### SUMMARY

In one aspect, a voltage regulation device includes: a plurality of taps; a first electrical contact configured to connect to one of the plurality of taps; a second electrical contact configured to connect to one of the plurality of taps; and a network electrically connected to the first electrical contact and to the second electrical contact. The network is configured to control a voltage differential between the first electrical contact and the second electrical contact or an amount of current that flows in the first electrical contact and the second electrical contact.

Implementations may include one or more of the following features.

The network may be configured to control an impedance of a current path between the first electrical contact and the second electrical contact.

The network may be configured to control the voltage differential between the first electrical contact and the second electrical contact to be substantially the same as a voltage differential between a first one of the plurality of taps connected to the first electrical contact and a second one of the plurality of taps prior to connecting the second electrical contact to the second one of the plurality of taps.

The network may be configured to control the voltage differential between the first electrical contact and the second electrical contact to be zero volts (V) prior to removing the first electrical contact or the second electrical contact from one of the plurality of taps.

The network may be configured to provide a low impedance circuit current path between the first electrical contact and the second electrical contact prior to removing the first electrical contact or the second electrical contact from one of the plurality of taps. The voltage regulation device also may include a preventive autotransformer, and the network may be in parallel with the preventive autotransformer. The network may be configured to reduce or prevent magnetic saturation of a magnetic core of the preventive autotransformer. The voltage regulation also may include a controller, the controller configured to access one or more design parameters of the voltage regulation device, and the controller is configured to control the network based on the one or more design parameters. The controller may be configured to access the one or more design parameters from an electronic storage of the controller.

In some implementations, the network includes: a rectifier configured to convert alternating current (AC) electrical power to direct current (DC) electrical power; an inverter configured to convert DC electrical power to AC electrical power; and a DC link electrically connected to the rectifier and the inverter. In these implementations, the inverter may be electrically connected to the first electrical contact and the second electrical contact. The network may be configured to control a voltage differential between the first electrical contact and the second electrical contact by generating a voltage. The network may be configured to control a current in the first electrical contact or the second electrical contact by injecting a current that flows in the first electrical contact or the second electrical contact.

The network may include a multi-position switch and a winding, where the winding is configured to be magnetically coupled to an AC power source.

In some implementations, the network does not include a coil configured to be magnetically coupled to an AC power source.

The voltage regulation device also may include: a first coil; a second coil; and a magnetic core configured to magnetically couple the first coil and the second coil. The network may be electrically connected to the first coil and the second coil, and the network may be configured to reduce or prevent magnetic saturation of the magnetic core.

In another aspect, an apparatus for a voltage regulation device includes: a network including at least one electrical element, the network configured to electrically connect in parallel with a preventive autotransformer of the voltage regulation device and to electrically connect to a first electrical contact of the voltage regulation device and to a second electrical contact of the voltage regulation device. The network is configured to control a current in one or more of the first electrical contact and the second electrical contact or to control a voltage difference between the first electrical contact and the second electrical contact.

Implementations may include one or more of the following features.

The network may be configured to electrically connect directly to the first electrical contact of the voltage regulation device and directly to the second electrical contact of the voltage regulation device.

The network may be configured to reduce or prevent magnetic saturation of the magnetic core of the preventive autotransformer.

The apparatus may be coupled to a controller that is configured to access one or more design parameters of the voltage regulation device, and the controller may be configured to control the network based on the one or more design parameters.

Implementations of any of the techniques described herein may include a voltage regulation device, a load tap changer, an apparatus, a network, a kit for retrofitting an existing voltage regulation device with a network, a controller for controlling a voltage regulation device and/or a network electrically connected to a voltage regulation device, or a process. The details of one or more implementations are set forth in the accompanying drawings and the description below. Other features will be apparent from the description and drawings, and from the claims.

### DRAWING DESCRIPTION

FIG. 1 is a block diagram of an electrical power system.

FIG. 2 is a block diagram of a voltage regulation device.

FIGS. 3A-3D are block diagrams of another voltage regulation device.

FIGS. 4A-4E are block diagrams of another voltage regulation device.

FIG. 5 shows a network that may be used in a voltage regulation device.

FIGS. 6A and 7A-7E are block diagrams of another voltage regulation device.

FIG. 6B shows another network that may be used in a voltage regulation device.

FIGS. 8A and 8B are examples of simulated data.

### DETAILED DESCRIPTION

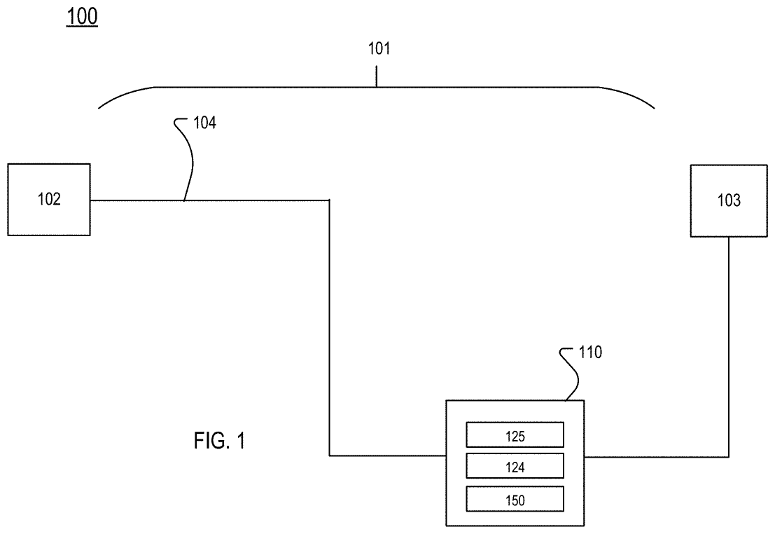

FIG. 1 is a block diagram of an example of an alternating-current (AC) electrical power system 100. The electrical power system 100 includes an electrical power distribution network 101 that transfers electricity from a power source 102 to electrical loads 103 through a distribution path 104 and an electrical apparatus 110. The electrical apparatus 110 is any apparatus that is capable of regulating the voltage to the loads 103. For example, the electrical apparatus 110 may be a voltage regulator that includes a load tap changer. The electrical power distribution network 101 may be, for example, an electrical grid, an electrical system, or a multi-phase electrical network that provides electricity to industrial, commercial and/or residential customers. The electrical power distribution network 101 may have an operating voltage of, for example, at least 1 kilovolt (kV), 12 kV, up to 34.5 kV, up to 38 kV, or 69 kV or higher, and may operate at a system frequency of, for example, 50-60 Hertz (Hz). The distribution path 104 may include, for example, one or more transmission lines, electrical cables, and/or any other mechanism for transmitting electricity.

The electrical apparatus 110 includes taps 125, movable contacts 124, and a network 150 that controls a voltage difference between two of the movable contacts 124 and/or controls a current that flows in two of the movable contacts 124. The taps 125 and the contacts 124 are made of an electrically conductive material, such as, for example, copper or another metal. The contacts 124 are configured to be electrically connected to and disconnected from the taps 125. At any given time, each electrical contact 124 may be electrically connected to one of the taps 125 or not electrically connected to any of the taps 125. More than one electrical contact 124 may be connected to the same one of the taps 125 at the same time.

The network 150 is electrically connected to the contacts 124. The electrical connection between the network 150 and the contacts 124 may be a direct electrical contact (with no other electrical elements between the network 150 and the contacts 124) or an indirect electrical contact (with one or more other electrical elements between the network 150 and the contacts 124).

Various implementations of the network 150 are discussed below. Prior to discussing the various implementations of the network 150, an overview of a voltage regulation device that includes a load tap changer is provided.

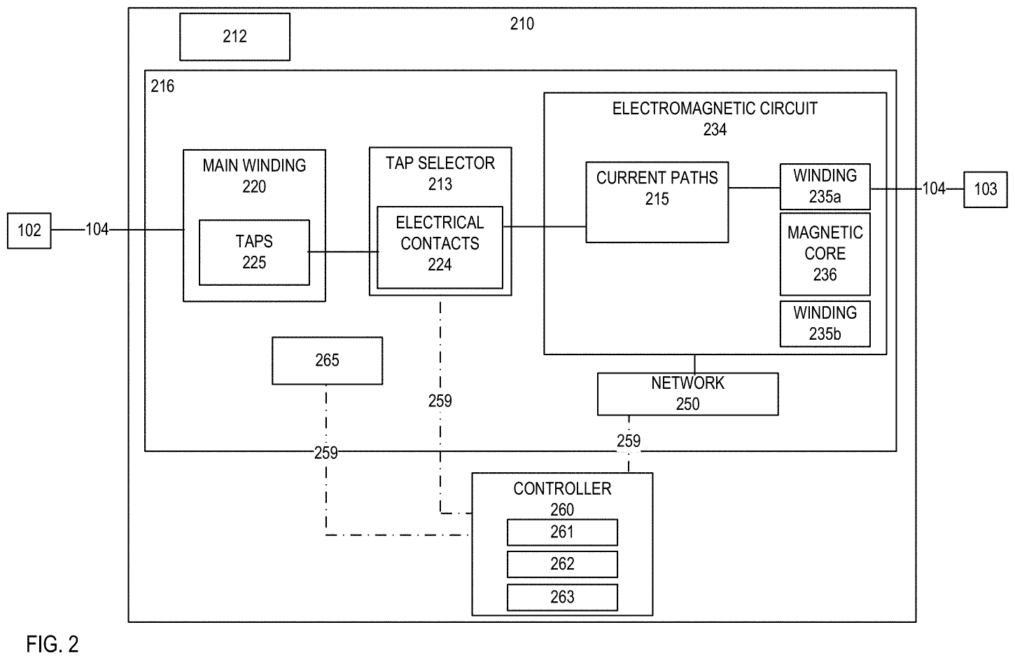

Referring to FIG. 2, a block diagram of a voltage regulation device 210 is shown. In the example of FIG. 2, the dash-dot lines indicate a data link 259 over which data, such as, for example, information, commands, or numerical data, travel. Solid lines between blocks indicate a path through which current flows between the source 102 and the load 103. The voltage regulation device 210 is an example of an implementation of the electrical apparatus 110 (FIG. 1). The load tap changer includes taps 225 and electrical contacts 224. The voltage regulation device 210 monitors and controls the voltage level at the distribution path 104 such that the voltage delivered to the electrical loads 103 (FIG. 1) is maintained within a desired or acceptable voltage range despite changes in the electrical load 103 and/or changes in the voltage supplied by the source 102 (FIG. 1).

The voltage regulation device 210 includes a monitoring module 212, a tap selector 213, a main winding 220, and at least two taps 225 electrically connected to the main winding 220. The monitoring module 212 may be any type of device capable of measuring or determining the voltage on the distribution path 104. For example, the monitoring module 212 may be a voltage sensor. The tap selector 213 may include, for example, motors, mechanical linkages, and/or electronic circuitry that is capable of connecting the load 103 to the source 102 through any of the taps 225. The voltage regulation device 210 also includes an electromagnetic circuit 234. Together, the taps 225, the main winding 220, the tap selector 213, and the electromagnetic circuit 234 form a voltage regulation operation module 216 for the voltage regulation device 210.

The tap selector 213 is configured to move an electrical contact 224 and place the electrical contact 224 on a particular one of the taps 225. When one or more of the electrical contacts 224 is connected to one or more of the taps 225, the electromagnetic circuit 234 electrically connects the main winding 220 to the electrical load 103. The taps 225 are separated from each other on the main winding 220, and the output voltage of the voltage regulation device 210 depends on the location of the selected tap on the main winding 220. Thus, by controlling which of the taps 225 is connected to the contact or contacts that carry the load current, the output voltage to the load 103 is also controlled. In this way, the voltage delivered to the electrical load 103 may be kept within the acceptable or desired range even if the voltage delivered from the power source 102 changes.

The electromagnetic circuit 234 includes current paths 215. The current paths 215 are any electrically conductive path that is able to conduct current from the contacts 224 to the load 103. The current paths 215 may be any type of electrical cable, transmission line, or wire. The electromagnetic circuit 234 also includes windings 235a and 235b, which are wrapped around a magnetic core 236 and are also electrically connected to one of the contacts 224. The magnetic core 236 may be an un-gapped or gapped magnetic core.

The electromagnetic circuit 234 is electrically connected to a network 250. For example, the electromagnetic circuit 234 may be in parallel with the electromagnetic circuit. The network 250 may be, for example, a voltage source. The network 250 controls a voltage differential, a voltage difference, or a potential difference between two or more of the contacts 224 and/or controls a current that flows in one or more of the contacts 224. The voltage regulation device 210 includes an on-load tap changer, meaning that the loads 103 remain connected to the source 102 when an electrical contact 224 is removed from one of the taps 225 and when the electrical contact 224 is connected to one of the taps 225. Because the loads 103 remain connected, removing a contact 224 from and/or connecting a contact 224 to a tap 225 may generate an arc, which reduces the lifetime of the electrical contact 224. The network 250 controls the current in the electrical contact 224 by controlling a voltage difference between two of the contacts 224. By controlling the current in the electrical contact 224, the network 250 provides reduced or eliminated arcing and a longer lifetime for the voltage regulation device 210. Moreover, the network 250 mitigates in-rush currents that could otherwise occur when a contact 224 is connected to a tap 225.

The voltage regulation device 210 also includes a sensor 265 that measures voltage and current in various portions of the electromagnetic circuit 234 and/or to the electrical load 103.

The sensor 265 may be located anywhere along the current paths 215. In some implementations, the electromagnetic circuit 234 includes more than one sensor 265. The sensor 265 provides data to a controller 260 via a data link 259. The data link 259 may be any path capable of transmitting data. For example, the data link 259 may be a network cable (such as an Ethernet cable), or the data link 259 may be a wireless connection that is capable of transmitting data.

The controller 260 may be implemented as an electronic controller that includes one or more electronic processors 261 and an electronic storage 262 coupled to the one or more electronic processors 261. The controller 260 also may include manual or electronic I/O interface or user interface devices 263 that allow an operator of the voltage regulation device 210 to communicate with the controller 260. The controller 260 may store instructions, perhaps in the form of a computer program, on the electronic storage 262. The instructions may relate to manipulation of data received from the sensor 265. Furthermore, the electronic storage 262 may store various design parameters or other information relating to the voltage regulation device 210. For example, the electronic storage 262 may store a total number of turns on the main winding 220, the number of turns between each of the taps 225, the number of turns on an equalizer winding (in implementations that include an equalizer winding), the impedance of the main winding 220 between each of the taps 225, the impedance of the equalizer winding (in implementations that include an equalizer winding), the impedance of the coils 235a and 235b, and/or parameters related to the magnetic flux of the preventive autotransformer 234. The parameters related to the magnetic flux of the autotransformer 234 may include, for example, magnetizing impedance of the autotransformer 234, number of turns on the windings 235a and 235b, the cross-sectional area of the core 236, the flux density limit of the core 236, and/or the volt-second limit of the core 236. The design parameters and/or other information related to the voltage regulation device 210 may be stored on the electronic storage 262 when the device 210 is manufactured or while the device 610 is deployed. The controller 260 may be programed with the parameters and/or other information by an operator via the I/O interface 263.

The controller 260 also may interact with the network 250. For example, the controller 260 may produce signals that, when received by the network 250, are sufficient to cause electronic components (for example, transistors) within the network 250 to perform certain actions. In another example, the instructions stored on the electronic storage 262 may include various procedures, routines, processes, and/or functions that use the parameters and/or other information to control the network 250.

In greater detail, in implementations in which the controller 260 is an electronic controller, the one or more electronic processors 261 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 262 may be any type of electronic memory that is capable of storing data and instructions in the form of computer programs or software, and the electronic storage 262 may include volatile and/or non-volatile components. The electronic storage 262 and the one or more processors 261 are coupled such that the processor 261 is able to access or read data from and write data to the electronic storage 262.

The I/O interface 263 may be any interface that allows a human operator and/or an autonomous process to interact with the control system 260. The I/O interface 263 may include, for example, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 263 also may allow communication without physical contact through, for example, an IEEE 802.11, Bluetooth, or a near-field communication (NFC) connection. The control system 260 may be, for example, operated, configured, modified, or updated through the I/O interface 263.

The I/O interface 263 also may allow the control system 260 to communicate with systems external to and remote from the voltage regulation device 210. For example, the VO interface 263 may include a communications interface that allows communication between the control system 260 and a remote station (not shown), or between the control system 260 and a separate electrical apparatus in the power system 100 (FIG. 1) using, for example, the Supervisory Control and Data Acquisition (SCADA) protocol or another services protocol, such as Secure Shell (SSH) or the Hypertext Transfer Protocol (HTTP). The remote station may be any type of station through which an operator is able to communicate with the control system 260 without making physical contact with the control system 260. For example, the remote station may be a computer-based work station, a smart phone, tablet, or a laptop computer that connects to the control system 260 via a services protocol, or a remote control that connects to the control system 260 via a radio-frequency signal. The control system 260 may communicate information such as the determined tap position through the I/O interface 263 to the remote station or to a separate electrical apparatus.

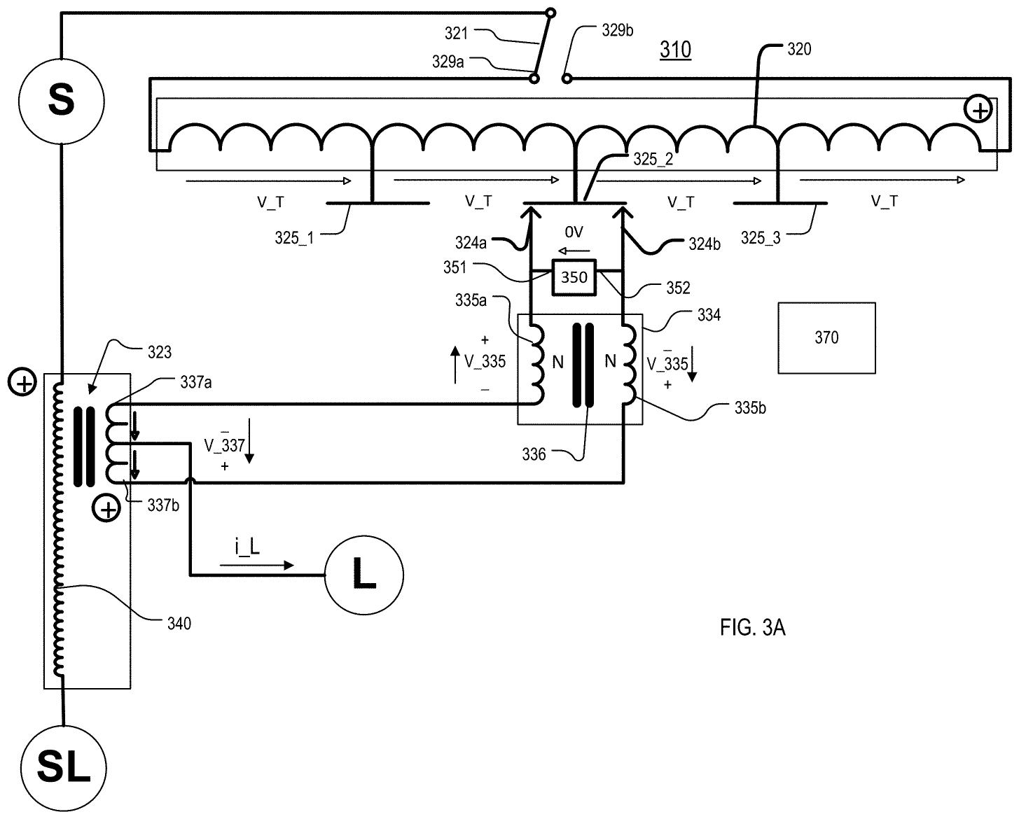

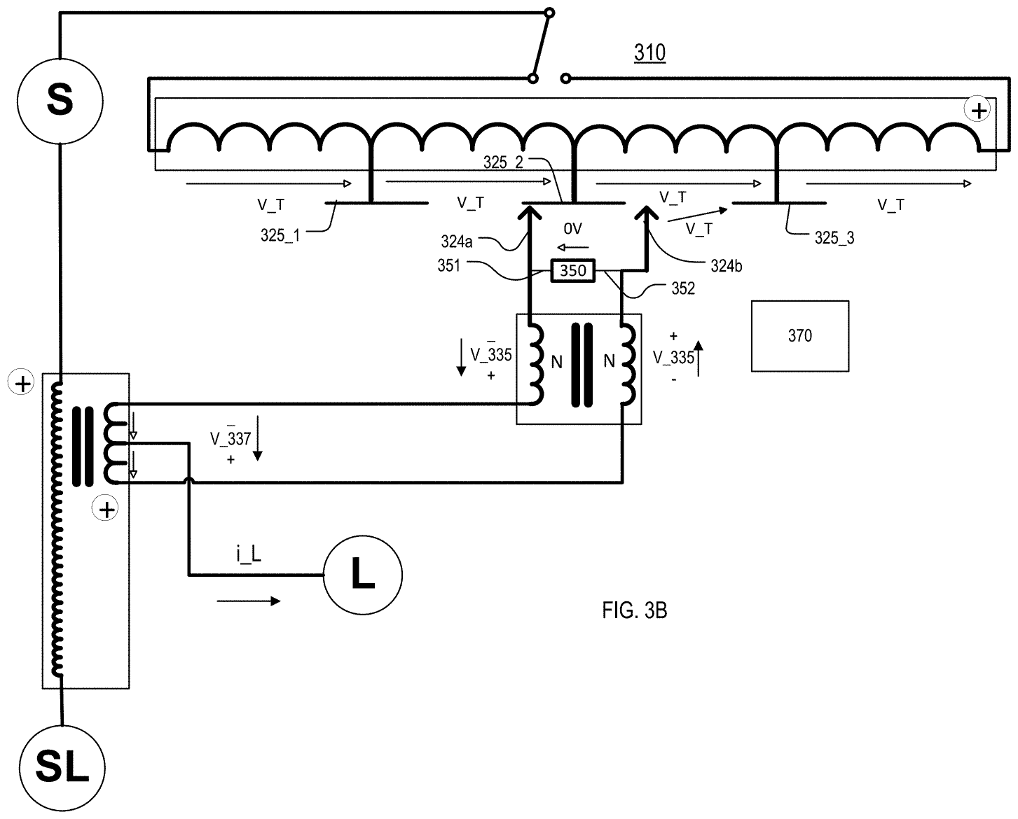

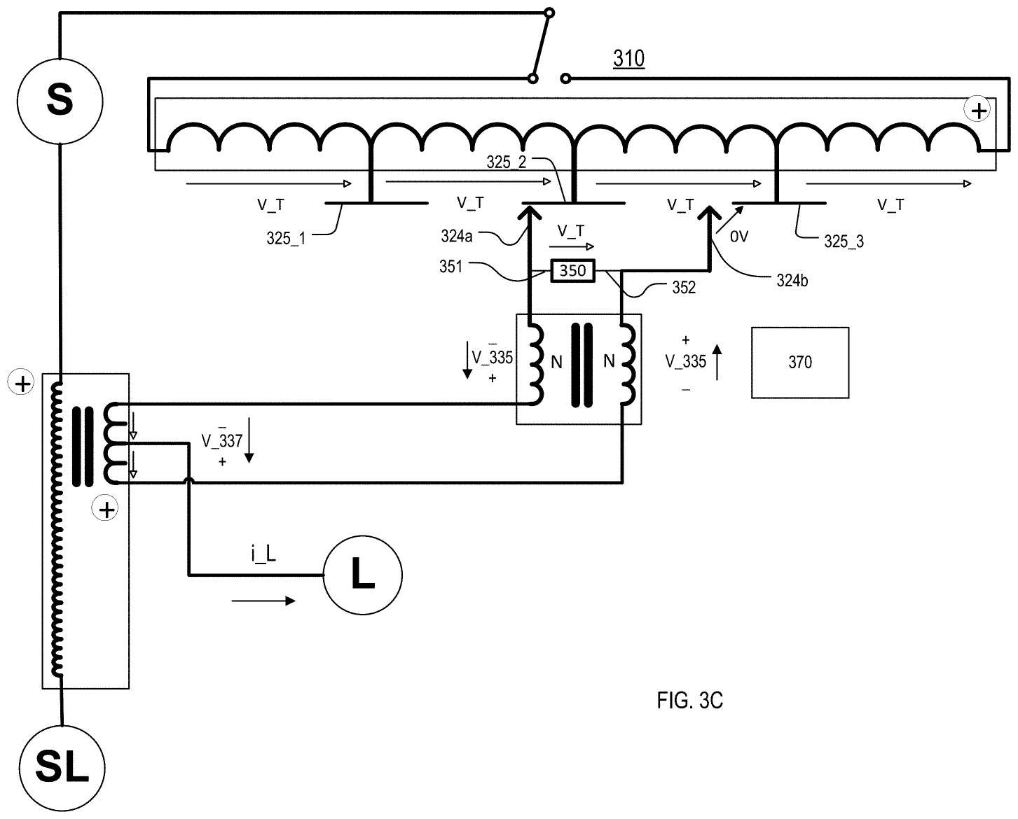

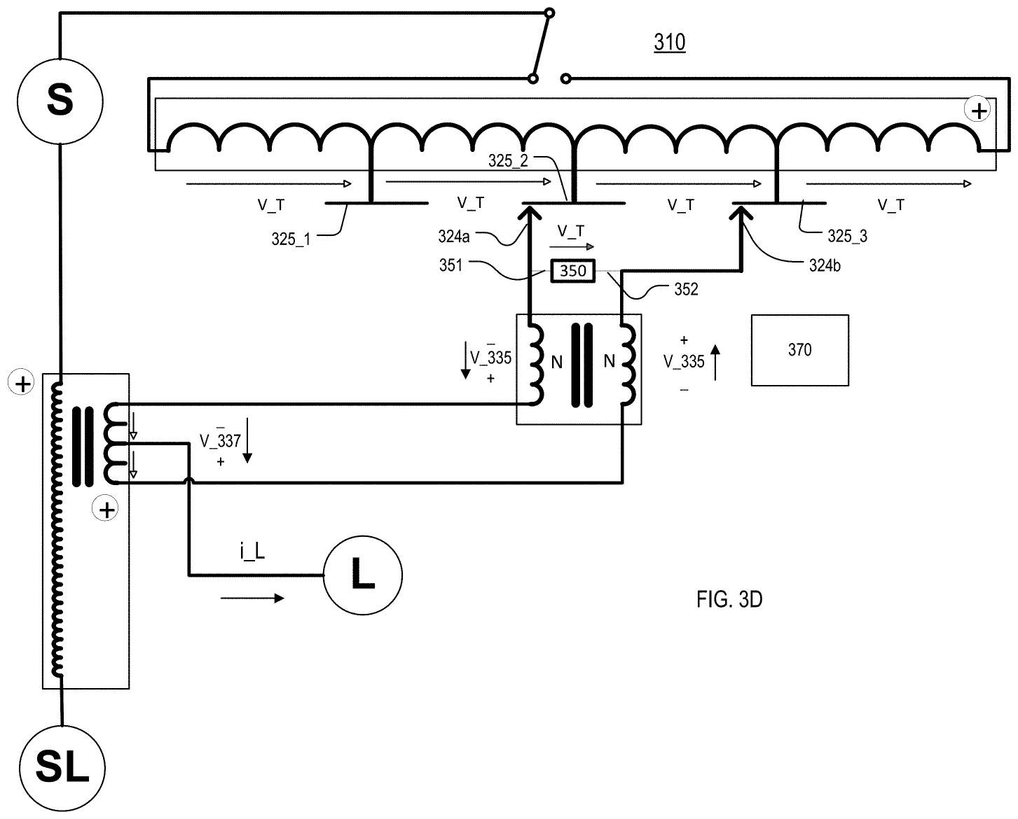

FIGS. 3A-3D are block diagrams of an example of a voltage regulation device 310 that includes a network 350 and moveable contacts 324a and 324b. Each of the FIGS. 3A-3D shows the voltage regulation device 310 at a different time. FIG. 3A shows an example of the voltage regulation device 310 operating in steady-state. FIGS. 3B and 3C show the voltage regulation device 310 during a switching operation. FIG. 3D shows another example of the voltage regulation device 310 operating in steady-state. The network 350 is electrically connected directly to the contacts 324a and 324b.

An overview of the operation of the voltage regulation device 310 is provided prior to discussing the network 350 in greater detail. The voltage regulation device 310 includes source, load, and source-load terminals, which are labeled, respectively, S, L, and SL. The voltage regulation device 310 may be enclosed in a housing (not shown). In these implementations, each of the S, L, and SL terminals is part of a bushing that is accessible from the exterior of the housing to allow the voltage regulation device 310 to be connected to other components in the power system 100 (FIG. 1). For example, the L terminal may be connected to the load 103, and the S terminal may be connected to the source 102. The L and S terminal names are simply a matter of convention. Dynamic system conditions may cause power to flow from the L terminal to the S terminal or from the S terminal to the L terminal.

The voltage regulation device 310 includes a shunt winding 340 between the S terminal and the SL terminal and a series winding 320 between the S terminal and the L terminal. The voltage regulation device 310 also includes a switch 321 that is used to control the polarity of the voltage on the series winding 320. One side of the switch 321 is connected to the S terminal. The other side of the switch 321 may be connected to a terminal 329a or to a terminal 329b. When the switch 321 is connected to the terminal 329a, the voltage across the series winding 320 adds to the voltage of the shunt winding 340. When the switch 321 is connected to the terminal 329b, the voltage across the series winding 320 subtracts from the voltage of the shunt winding 340.

Each of the shunt winding 340 and the series winding 320 is made of an electrically conductive material, such as a metal. The shunt winding 340 and the series winding 320 are wound around a magnetic core 323. Each of the wound shunt winding 340 and the series winding 320 may form, for example, a helix. Each portion of the winding 320 or the winding 340 that encircles the core 323 is referred to as a turn. The series winding 320 has M turns, where M is an integer number that is greater than one. The shunt winding 340 has N turns, where N is an integer number that is greater than one. M and N may be the same or different values. In other words, the shunt winding 340 and the series winding 320 may have different numbers of turns.

The magnetic core 323 is made of a ferromagnetic material, such as, for example, iron or steel. The magnetic core 323 may be a gapped core or an un-gapped core. In implementations in which the core 323 is an un-gapped core, the core 323 is a contiguous segment of ferromagnetic material. A gapped core includes a gap that is not ferromagnetic material. The gap may be, for example, air, nylon, or any other material that is not ferromagnetic. Thus, in implementations in which the core 323 is a gapped core, the core includes at least one segment of a ferromagnetic material and at least one segment of a material that is not a ferromagnetic material.

The shunt winding 340 is electrically connected to the S terminal, which receives electricity from the source 102 (FIG. 1) via the distribution path 104. When the S terminal receives electricity, the shunt winding 340 is energized and a time-varying (AC) current flows in the shunt winding 340. The shunt winding 340 and the series winding 320 are magnetically coupled by the core 323. Thus, when the AC current flows in the shunt winding 340, a corresponding time-varying current is induced in the series winding 320.

The series winding 320 includes T taps 325, where T is an integer number that is greater than one. During operational use of the voltage regulation device 310, there is a potential difference V_T between any two adjacent taps 325. In the example of FIG. 3A, three taps are shown. The three taps are labeled 325_1, 325_2, and 325_3. Thus, the voltage between the taps 325_1 and 325_2 and between the taps 325_2 and 325_3 is V_T. In the example shown, the tap 325_2 is at a higher potential than the tap 325_1, and the tap 325_3 is at a higher potential than the tap 325_2.

The taps are collectively referred to as the taps 325. The taps 325 are made of an electrically conductive material (such as, for example, metal), and the taps 325 are electrically connected to the series winding 320. Each tap is separated from the nearest other tap, with at least one of the M turns being between any two adjacent taps 325. In the example of FIG. 3A, there are four turns between any two adjacent taps (for example, there are four turns between the tap 325_1 and the tap 325_2). Other implementations are possible. For example, more or fewer turns may be between two adjacent taps. The series winding 320 may include more or fewer taps.

Each of the movable contacts 324a and 324b is electrically connected to an electromagnetic circuit 334, which is a reactor or a preventive autotransformer. The electromagnetic circuit 334 includes two coils 335a, 335b that are wound around a common core 336. The contact 324a is electrically connected to the coil 335a, and the contact 324b is electrically connected to the coil 335b. The coils 335a and 335b are also electrically connected to the L terminal via an equalizer 337. The equalizer includes coils 337a and 337b.

The voltage at the L terminal is determined by which one or two of the taps 325 is selected by (in electrical contact with) the electrical contacts 324a and 324b. A driving system 370 controls the motion and position of the electrical contacts 324a and 324b. The driving system 370 may include, for example, mechanical linkages and motors that are used to move either or both of the moveable contacts 324a, 324b to a particular one of the taps 325. The driving system 370 is shown as being physically separated from the movable contacts 324a and 324b, but may be implemented to be mechanically coupled to the movable contacts 324a and 324b or to a device that is mechanically coupled to the movable contacts 324a and 324b.

When both of the electrical contacts 324a and 325b are in electrical contact with the same one of the taps 325, the tap position is a non-bridging position. In the example of FIG. 3A, the electrical contacts 324a and 324b are both on the tap 325_2. Thus, the example of FIG. 3A shows a non-bridging position. When one of the electrical contacts 324a, 324b is in electrical contact with one of the taps 325 and the other of the electrical contacts 324a, 324b is in electrical contact with another one of the taps 325, the tap position is a bridging position. FIG. 3D shows an example of a bridging position.

The voltage regulation device 310 makes a step or a tap change each time one of the electrical contacts 324a and 324b is removed from its current tap and placed into electrical contact with a different tap. In other words, a step change is an actuation from one acceptable steady-state tap position to an adjacent steady-state tap position. When one of the electrical contacts 324a or 324b is disconnected from one of the taps 325, the voltage regulation device 310 is in a switching state or is performing a switching operation.

The network 350 controls the voltage difference between the contact 324a and the contact 324b and/or a current that flows in the contact 324a and/or 325b. The network 350 includes a first node 351 and a second node 352. The first node 351 is directly connected to the contact 324a. The second node 352 is directly connected to the contact 324b. The network 350 may be connected to a control system (such as the controller 260). In these implementations, the control system controls the network 350. For example, the control system controls the voltage and/or current produced by the network 350.

Referring to FIG. 3A, the contacts 324a and 324b are electrically connected to the tap 325_2. The contacts 324a and 324b are in a non-bridging condition. In FIG. 3A, the network 350 does not provide a voltage difference between the contacts 324a and 324b, and the contacts 324a and 324b are at the same potential. In other words, there is no potential difference between the contact 324a and the contact 324b. Equal amounts of load current flows in each of the contacts 324a and 324b. There is also a circulating current in the circuit based on the voltage output of the equalizer 337 and the impedance of the preventive autotransformer 334. Therefore, total current flowing through each of the contacts 324a and 324b is the sum of the circulating current plus half of the load current. The network 350 provides a low-impedance path between the contact 324a and the contact 324b to reduce or eliminate arcing when the contact 324b is removed from the tap 325_2. In some typical or legacy voltage regulation devices, arcing may occur when a contact is removed from a tap. For instance, the inductive character of the preventive autotransformer 334 causes a high voltage to develop across coils 335a and 335b in opposition to an impedance to current flow such that an arc will be formed across the gap between the contact 324b and the tap 324_2 until the current reaches zero. On the other hand, the network 350 provides a low-impedance path between the contact 324a and the contact 324b. At the time that the contact 324b is removed from the tap 325_2, all of the load current from the tap 325_2 is flowing into the contact 324a because the network 350 provides a low-impedance path to the coil 335b, and the circulating current from the equalizer 337 and preventive autotransformer 334 flows through the second node 352, the network 350, and the first node 351. Thus, arcing between the contact 324b and the tap 325_2 that could otherwise occur when the contact 324b is removed from the tap 325_2 is eliminated or reduced.

Referring to FIG. 3B, a switching operation to disconnect the contact 324b from the tap 325_2 and connect the contact 324b to the tap 325_3 is in progress. At the time shown in FIG. 3B, the contact 324b has been removed from the tap 325_2 and has not yet been connected to the tap 325_3. There is still no potential difference between the contact 324a and the contact 324b. Accordingly, the potential difference between the contact 324b and the tap 325_3 is the same, or nearly the same (for example, the same to within a few percent), as the potential difference between the tap 325_2 and the tap 325_3.

Referring also to FIG. 3C, during the switching operation and while the contact 324b is not connected to one of the taps 325, the network 350 is controlled to adjust the flux in the magnetic core 336 and the potential difference between the contact 324a and 324b to reduce or eliminate in-rush currents or current transients. An in-rush current or a current transient may be caused by magnetic saturation of the core 336. For example, the magnetic flux of the core 336 is a function of the voltage across the coils 335a and 335b, and so magnetic flux in the core 336 varies with time. A sudden shift in the voltage magnitude or phase can cause the flux density to rise beyond the limits of the core material (saturation) effectively lowering the impedance of the preventive autotransformer 334, resulting in in-rush current. In-rush currents may have relatively large amplitudes. Thus, it may be beneficial to avoid or reduce in-rush currents. The network 350 is controlled to adjust the potential difference between the contact 324a and the contact 324b to be V_T (which is the potential difference between the tap 324_2 and the tap 325_3), which can be done by changing the output voltage vector of the network 350 instantaneously when the net magnetic flux in the core 336 is near zero or by changing the output voltage vector gradually while maintaining the magnetic flux of the core 336 within its saturation limits. By adjusting the voltage difference in this way, there is no potential difference between the contact 324b and the tap 325_3 when the contact 324b connects to the tap 325_3, and in-rush currents are mitigated. For example, if the potential difference between the tap 325_2 and the tap 325_3 is 96V, and the tap 325_3 is at a relatively higher potential than the tap 325_2, the potential difference provided by the network 350 is 96V, with the contact 324b being held at a relatively higher potential than the contact 324a.

Referring also to FIG. 3D, the voltage regulation device 310 is shown in a bridging position in steady-state. The contact 324a remains connected to the tap 325_2, and the contact 324b is connected to the tap 325_3. When the tap 325_3 was connected to the tap 325_3, no in-rush current was produced or only a relatively small in-rush current was produced due to the voltage provided by the network 350. The network 350 need not continue to provide the voltage differential between the contact 324a and the contact 324b upon completion of the tap change and may act as an open circuit.

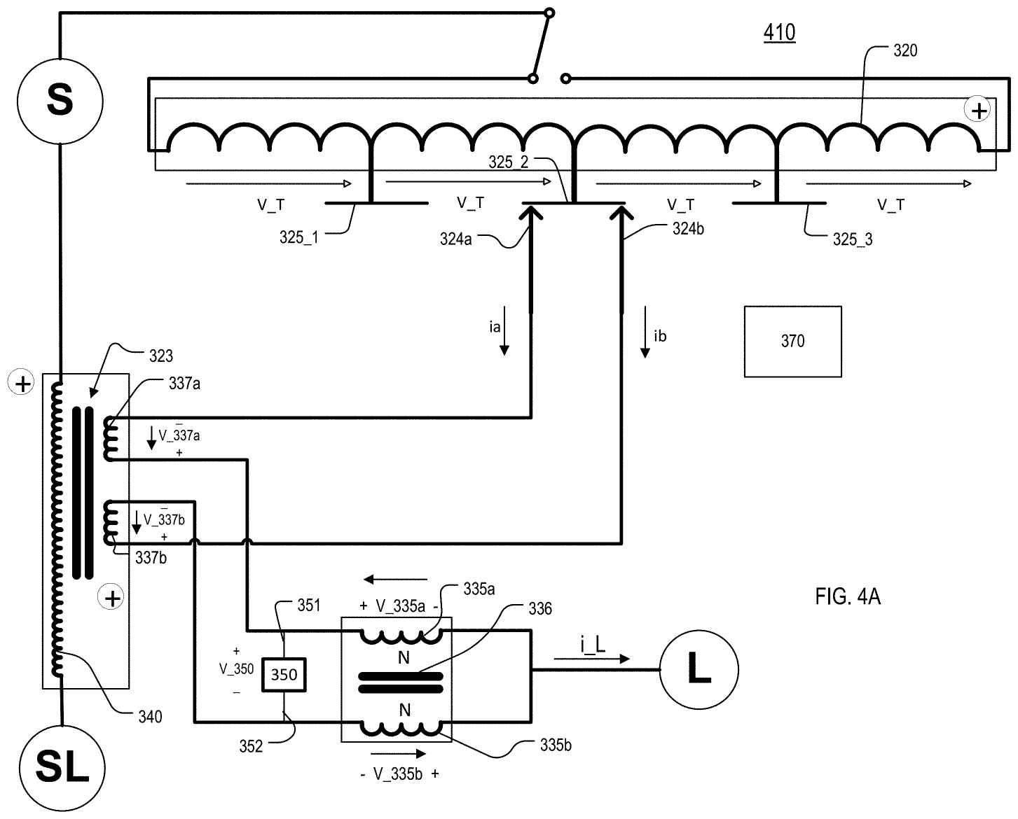

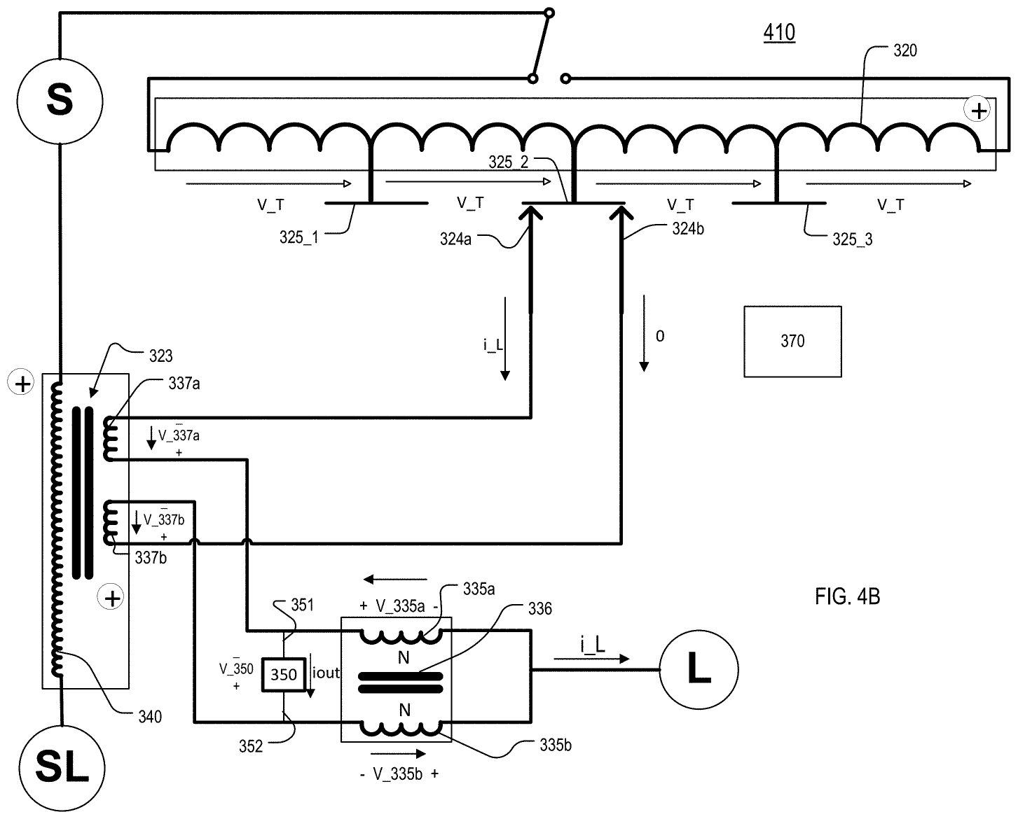

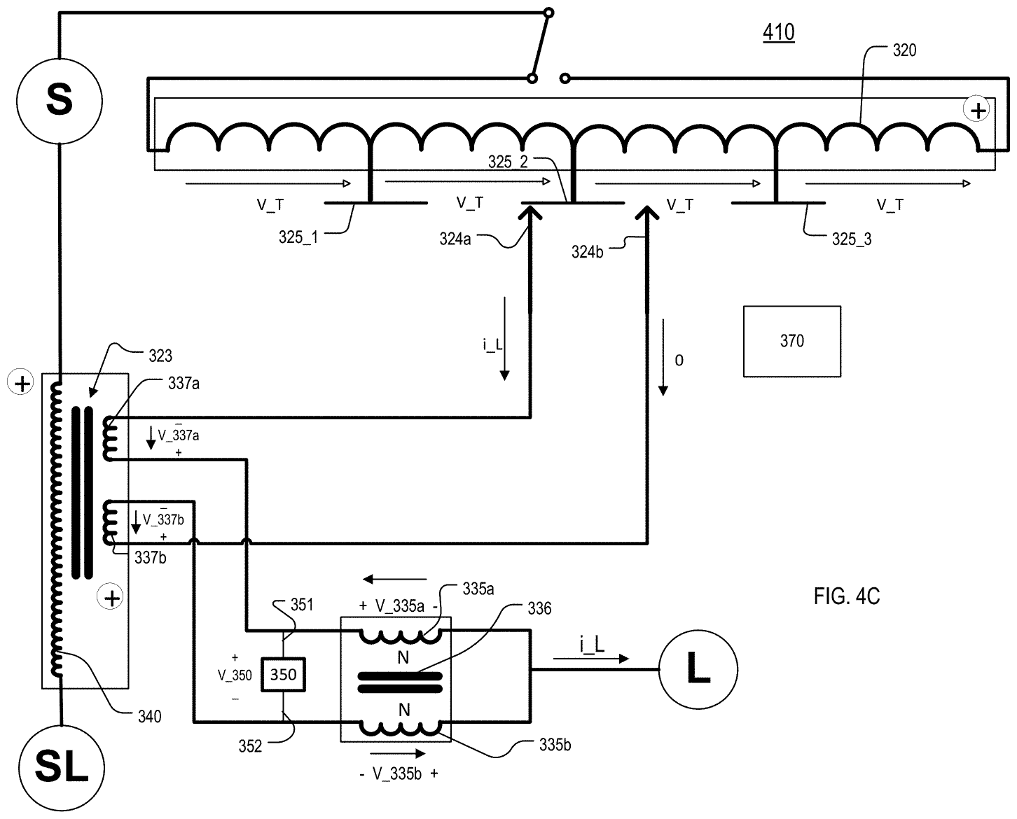

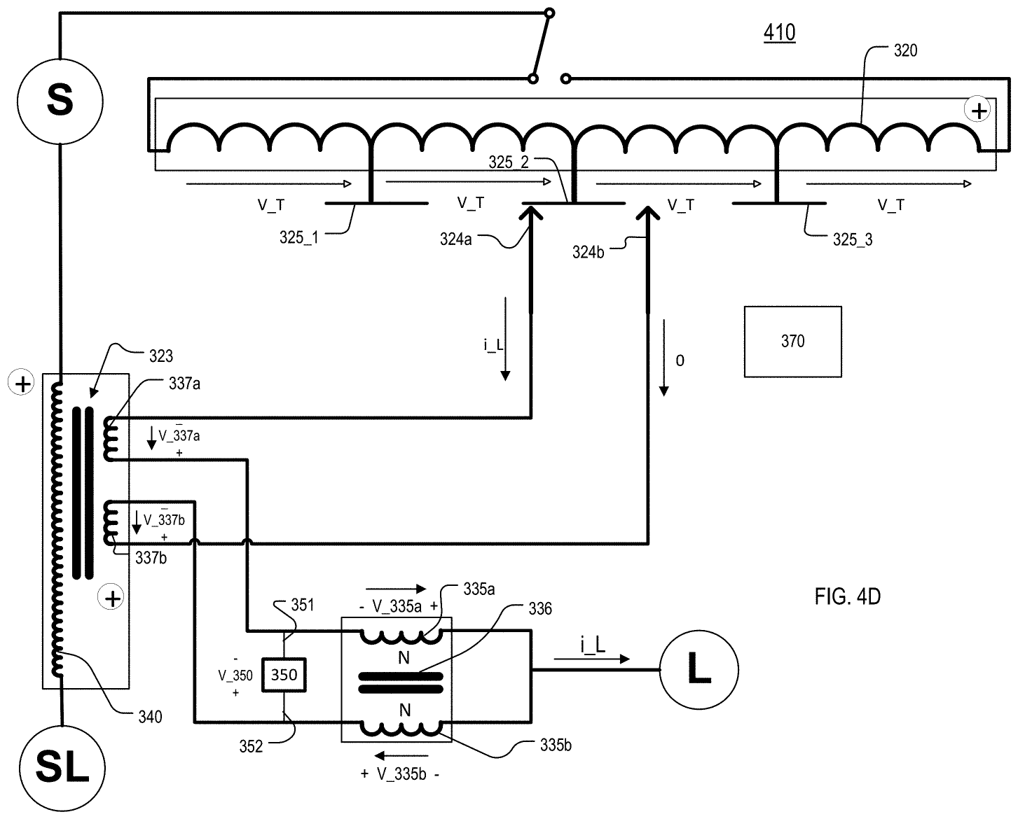

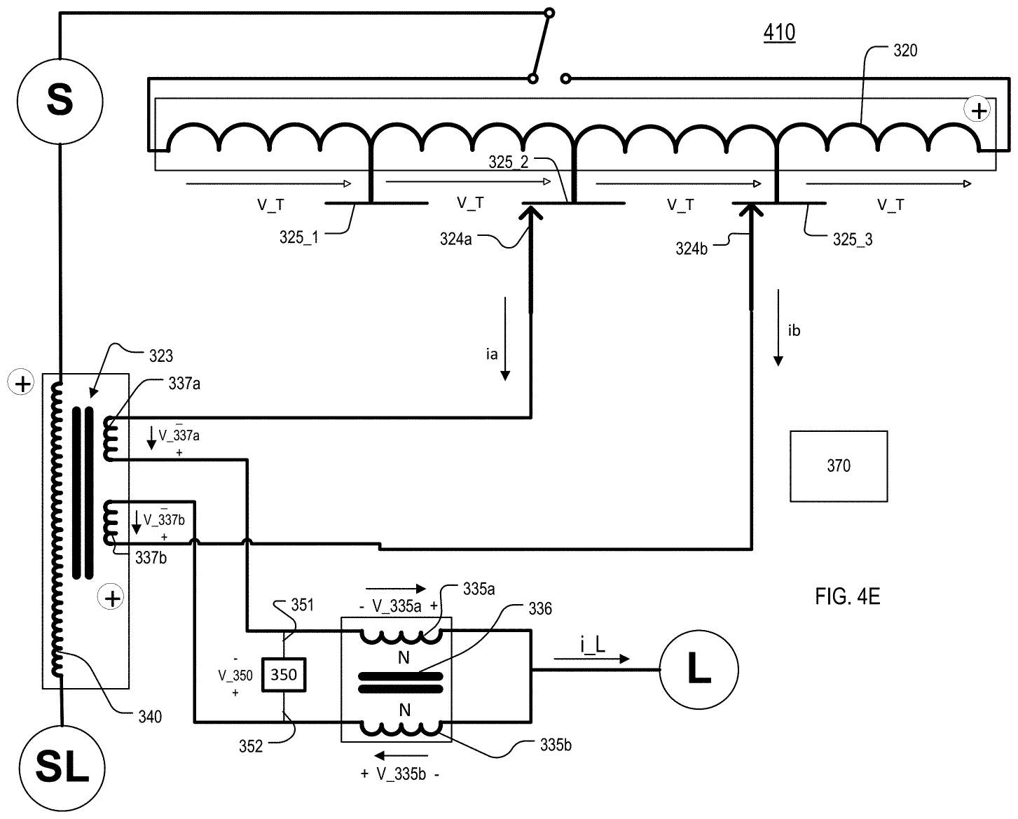

FIGS. 4A-4E show another voltage regulation device 410 at four different times. The voltage regulation device 410 is similar to the voltage regulation device 310 and has many of the same components. However, in the voltage regulation device 410, the network 350 is not directly connected to the movable contacts 324a and 324b. Instead, the network 350 is indirectly connected to the movable contacts 324a and 324b. The moveable contacts 324a and 324b are electrically connected to the electromagnetic circuit 334 through the equalizer 337. Specifically, the movable contact 324a is electrically connected to the coil 337a of the equalizer, and the movable contact 324b is electrically connected to the coil 337b of the equalizer. The coil 337a is electrically connected to the coil 335a, and the coil 337b is electrically connected to the coil 335b. The coils 335a and 335b are electrically connected to the terminal L. The first node 351 of the network is electrically connected between the coil 337a and the coil 335a. The second node 352 is electrically connected between the coil 337b and the coil 335b.

FIG. 4A shows the voltage regulation device 410 in a steady-state non-bridging position. Both of the movable contacts 324a and 324b are connected to the tap 324_2. A current ia flows in the movable contact 324a. A current ib flows in the movable contact 324b. Each of the currents ia and ib is equal to half of the load current (i_L) plus the vector sum of the circulating current. The voltage across the equalizer coils 337a and 337b is, respectively, V_337a and V_337b. The magnitude of the voltage across the coils 335a and 335b is V_335a and V_335b, respectively. The magnitude of the voltages V_335a plus V_335b is equal to the magnitude of the voltages V_337a plus V_337b.

In FIG. 4A, the network 350 acts as an open circuit allowing a voltage difference V_350 between the first node 351 and the second node 352, with the first node 351 being at a relatively higher potential than the second node 352. The sum of the potential difference between the contacts 324a and 324b, the voltage V_337a, the voltage V_337b, and the voltage V_350 is zero. For example, if the voltage across each of the coils 337a and 337b is 24V, and the voltage difference between the contact 324a and the contact 324b is zero, the voltage difference between the first node 351 and the second node 352 is 48V. FIG. 4B shows the voltage regulation device 410 at a time just prior to a switching operation. In this example, the switching operation removes the contact 324b from the tap 325_2 and to connect the contact 324b to the tap 325_3. As discussed above, if current is flowing in a contact when the contact is removed from a tap, arcing may occur. To prevent or reduce arcing, the network 350 produces a current iout that counters the current ib, For example, the network 350 may be controlled to change the voltage between the first node 351 and the second node 352 such that the current iout is produced. The current iout cancels the current ib, For example, the current iout may have the same amplitude as the current ib but a phase that is 180° different than the phase of the current ib. In this way, the current flowing in the contact 324b is reduced to zero or nearly zero. Thus, when the contact 324b is removed from the tap 325_2, little or no arcing occurs.

FIG. 4C shows the voltage regulation device 410 during the switching operation and at a time after the contact 324b has been removed from the tap 324_2 but before the contact 324b has been connected to the tap 325_3. The potential difference between the first node 351 and the second node 352 is set to approximately equal to the sum of the voltage across the coil 337a and 337b (the same as in FIG. 4A) by controlling the network 350. This results in the contact 324a and the contact 324b being at the same potential. The current iout is half of the load current minus the circulating current. The potential difference between the contact 324b and the tap 325_3 is V_T. No current flows in the disconnected contact 324b, and all of the load current (i_L) flows in the contact 324a.

FIG. 4D shows the voltage regulation device 410 during the switching operation and at a time just after the time shown in FIG. 4C. As discussed above, if there is a potential difference (in magnitude and/or phase) between a contact and a tap when the contact connects to the tap, an in-rush current or transient current may flow in the voltage regulation device. The in-rush current or transient current may have a large amplitude and may damage components. Thus, reducing or eliminating the in-rush current or transient current may improve performance of the voltage regulation device 410. The network 350 is controlled to change the potential difference between the contacts 324a and 324b to be the same as the potential difference between the tap 325_2 and the tap 325_3 as follows. The sum of the potential difference between the contacts 324a and 324b, the voltage V_377a, the voltage V_337b, and the voltage V_350 is zero. Thus, if V_T is 96V, the voltage across each of the coils 337a and 337b is 24V with the polarity as shown, to create a potential difference of V_T between the contact 324a and 324b with the contact 324b at a relatively higher potential than the contact 324a, the voltage difference between the first node 351 and the second node 352 is set to 48V (by the network 350) with the second node 352 at a relatively higher potential than the first node 351. As discussed above, the change in the output voltage vector V_350 can be made instantaneously when the net magnetic flux in the core 336 is near zero or the vector change can be gradual while maintaining the magnetic flux within the limits of the core 336.

FIG. 4E shows the voltage regulation device 410 in a steady-state bridging position after the contact 324b has been connected to the tap 325_3. The in-rush current or transient current was eliminated or reduced by adjusting the potential difference between the contact 324a and the contact 324b as discussed above in FIG. 4D. In the steady-state bridging condition, the network 350 acts as an open circuit resulting in the voltage V_350 with the polarity as shown in FIG. 4D and 4E. Thus, the potential difference between the contact 324a and 324b remains at V_T, with the contact 324b having a relatively greater potential than the contact 324a. The currents is and ib again flow in the respective contacts 324a and 324b and are equal to half the load current plus the circulating current. In a bridging position, the circulating current is equal to the quotient of the dividend equal to the difference between the tap voltage V_T and the summed equalizer coil voltages V_337a and V_337b divided by the divisor equal to the impedance of the preventive autotransformer 334. It may be noted due to the relative polarities of the equalizer 337 and series winding 320, the direction of circulating current flow is opposite in bridging and non-bridging positions. Further embodiments may neglect the use of an equalizer 337 such that there is no circulating current in non-bridging positions and the circulating current in bridging positions is equal to the difference in potential between taps V_T divided by the impedance of the preventive autotransformer 334.

Accordingly, the network 350 controls the potential difference between the contact 324a and the contact 325b and/or controls a current flowing in the contact 324a and/or the contact 325b to thereby reduce or eliminate arcing when a contact is disconnected from tap and/or to reduce or eliminate in-rush currents when a contact is connected to a tap.

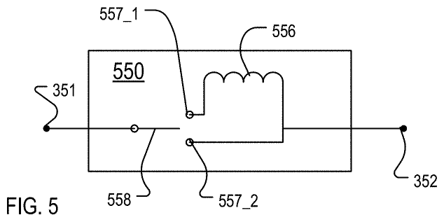

FIG. 5 is a schematic of a network 550. The network 550 may be used as the network 350 in the voltage regulation device 310 or 410. The network 550 includes a multi-position switch 558 and a coil 556. The switch 558 may be connected to a terminal 557_1, a terminal 557_2, or to neither of the terminals 557_1, 557_2. The coil 556 is configured to be magnetically connected to another coil that receives power from an AC source. For example, the coil 556 may be magnetically coupled to the main winding 320 (FIGS. 3A-3D and 4A-4E).

When the switch 558 is connected to the terminal 557_1, the coil 556 is electrically connected between the first node 351 and the second node 352. When the switch 558 is connected to the terminal 557_2, the coil 556 is not connected between the first node 351 and the second node 352, and there is a short circuit or a low-impedance path between the first node 351 and the second node 352. When the switch 558 is not electrically connected to the terminal 557_1 or the terminal 557_2, the network 550 is an open circuit. Thus, the network 550 may be used to provide a low-impedance path between the contact 324a and the contact 324b, to insert a voltage in parallel with the electromagnetic circuit 334, or to provide an open circuit.

For example, and referring to FIGS. 3A and 3B, in an implementation of the voltage regulation device 310 that uses the network 550 as the network 350, the switch 558 is connected to the terminal 557_2 just prior to removing the contact 324b from the tap 325_2. This provides a low-impedance path to the coil 335b, As a result, current from the tap 325_2 flows into the contact 324a but not into the contact 325b, thereby preventing or reducing arcing when the contact 324b is removed from the tap 325_2. Referring to FIGS. 3C and 3D, the switch 558 is connected to the terminal 557_1 to insert a voltage between the nodes 351 and 352. This allows the magnetic flux in the core 336 to be adjusted to mitigate in-rush currents.

To provide another example, referring to FIG. 4A, the network 550 is controlled such that the switch 558 is not connected to the terminal 557_1 or 557_2 such that the network 350 provides an open circuit at the time shown in FIG. 4A. At the time shown in FIG. 4B, network 550 is controlled such that the switch is connected to the terminal 557_1 so that the current iout is produced.

The network 550 is provided as one example of a configuration that may be used as the network 350. Other implementations are possible, and the network 350 may or may not include a coil such as the coil 556. The network 350 may be implemented as a full-bridge inverter with a DC bus, a full-bridge voltage source inverter, a full-bridge current source inverter, a multi-level inverter, a half-bridge inverter, or a cycloconverter, just to name a few. In some implementations, the network 350 is isolated from the voltage regulation device in which the network 350 is used. The network 350 may be isolated via magnetic field coupling (for example, the network 350 includes a coil that magnetically couples to a core). However, the network 350 may be isolated using an electric field coupling technique.

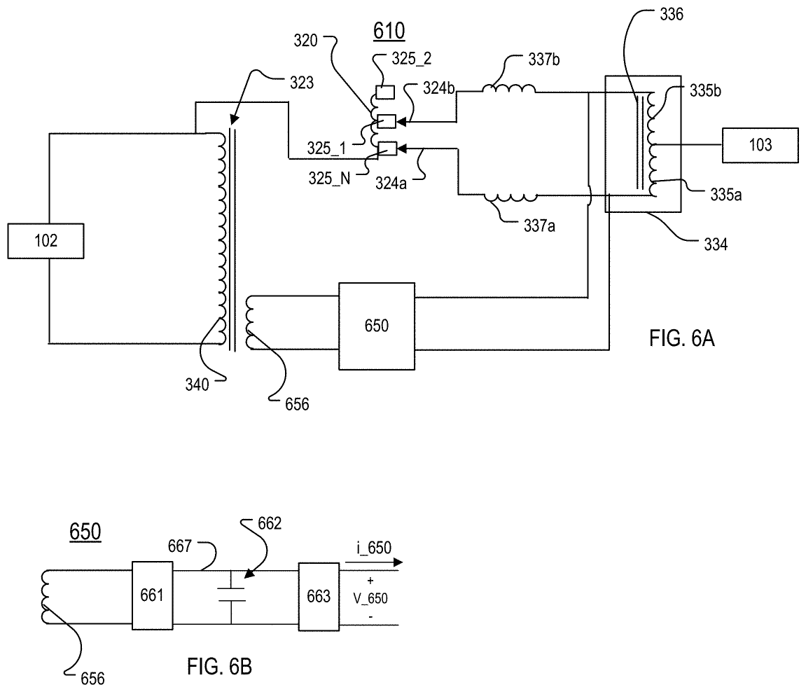

FIG. 6A is a schematic of another voltage regulation device 610. The voltage regulation device 610 includes a network 650. The network 650 includes a back-to-back converter (for example, a rectifier and an inverter coupled by a DC link). The back-to-back converter generates a voltage V_650 that balances the voltage difference V_T between two adjacent taps and controls magnetic flux in the core 336. The back-to-back converter also provides a low-impedance path. The network 650 allows the current in a connected contact to be reduced to zero or nearly zero prior to removing the contact from the tap, thereby preventing or reducing arcing. Moreover, even though the network 650 includes power electronics that generally experience relatively high levels of conduction loss, the power electronics are used only when balancing is needed. Thus, the conduction losses are mitigated.

FIG. 6B is a schematic of the network 650. The network 650 produces a voltage V_650 and a current i_650. The network 650 controls a potential difference between the moveable contacts 324a and 324b and/or controls a current in the moveable contact 324a and/or 324b and/or controls magnetic flux in the core 336 to reduce or eliminate arcing and in-rush currents. The voltage regulation device 610 includes the equalizer coils 337a and 337b, which are magnetically coupled by the core 323 (FIGS. 3A-3D). The equalizer coil 337a is electrically connected to the contact 324a. The equalizer coil 337b is electrically connected to the contact 325b. The voltage regulation device also includes the electromagnetic circuit 334, which is electrically connected to the load 103. The network 650 is in parallel with the electromagnetic circuit 334. In the example of the voltage regulation device 610, the network 650 is electrically connected between the equalizer coils 337a and 337b and the electromagnetic circuit 334.

The network 650 includes a coil 656. The coil 656 is magnetically coupled to the shunt winding 340. The shunt winding 340 receives AC power from the source 102. Thus, the AC power from the source 102 is also provided to the network 650. The network 650 also includes a rectifier 661, which converts the AC current that flows in the coil 656 to DC current that flows on a DC bus 667. A DC link 662 (for example, a network of capacitors and/or inductors) is electrically connected to the DC bus 667. The network 650 also includes an inverter 663. The inverter 663 is connected to the DC bus 667, and the inverter converts DC energy stored in the DC link 662 into the AC current i 650.

The rectifier 661 is any type of electrical network that is capable of converting an AC current into a DC current. The rectifier 661 may utilize controlled switches such that it can return power from the DC link 665 to the AC power system 100 through the coil 656, which is magnetically coupled to the shunt winding 340. The controlled switches may be, for example, transistors, such as, MOSFETS, BJTs, and/or IGBTs. Thus, in implementations in which controlled switches are used in the rectifier 661, the rectifier 661 serves two purposes. First, the rectifier converts AC current into DC current that is supplied to the DC link 662, which stores energy that the inverter 663 uses to produce the current i_650. Second, the rectifier 661 is able to compensate reactive power from the power distribution network 101. In other words, the rectifier 661 is able to accept reactive power, which may be expressed in units of volt-ampere reactive (VAr), and to provide reactive power to the power distribution network 101. The ability of the rectifier 661 to compensate reactive power improves the power factor in the power distribution network 101. Thus, the rectifier 661, when implemented with controllable switches, allows a single apparatus (the rectifier 661) to serve more than one purpose, thereby reducing the need for additional components and providing a more efficient design.

The inverter 663 is any type of electrical network that converts the DC energy in the DC link 662 into the current i_650. The inverter 663 includes a plurality of controllable switches (for example, transistors such as, MOSFETS, BJTs, and/or IGBTs), arranged in any configuration known in the art. The inverter 663 modulates the DC power into AC power by switching the controllable switches. For example, the inverter 663 may implement a pulse width modulation (PWM) technique. The characteristics (amplitude, frequency, and/or phase) of the AC current i_650 is determined by the switching of the controllable switches in the inverter 663.

In some implementations, the rectifier 661 and the inverter 663 are implemented as two H-bridges. An H-bridge is a circuit that includes four (4) switches. The switches may be, for example, transistors, diodes, or any other mechanism that may be configured to allow current to flow or to prevent the flow of current. In these implementations, the DC link 662 is a capacitor that is electrically connected between the rectifier 661 and the inverter 663.

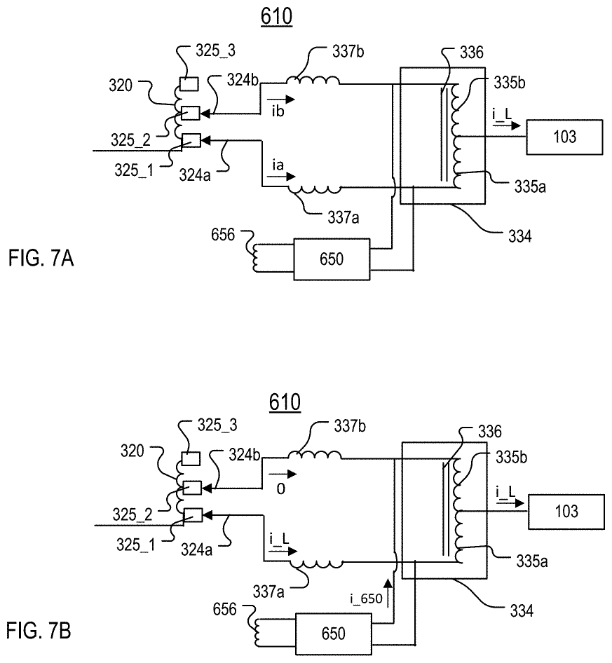

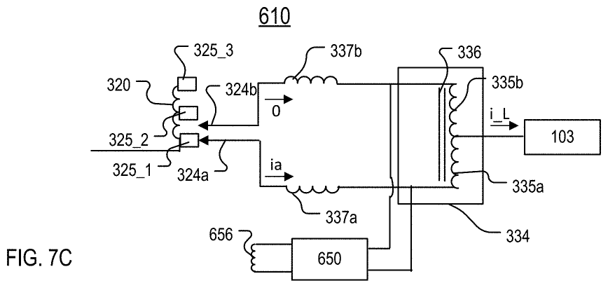

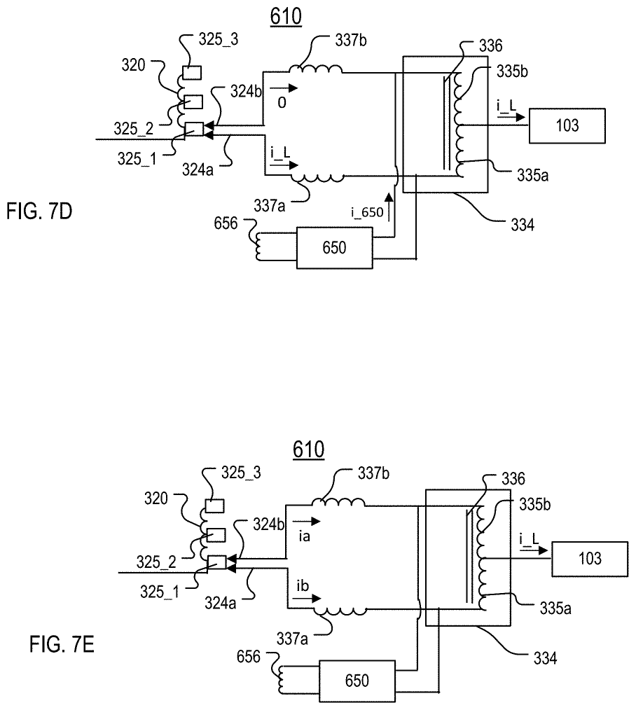

The operation of the network 650 is discussed with respect to FIGS. 7A-7E. Referring to FIG. 7A, the voltage regulation device 610 is shown in a steady-state bridging position. The contact 324b is connected to the tap 325_2. The contact 324a is connected to the tap 325_1. A current ia flows in the contact 324a, and a current ib flows in the contact 324b. The currents ia and ib are AC currents that have an amplitude that is half of the load current (i_L) plus the circulating current. At this point, the DC link 667 is pre-charged by the rectifier 661, and the inverter 663 is disabled. Thus, the power electronics in the inverter 663 are not conducting current.

FIG. 7B shows the voltage regulation device 610 just prior to a switching operation to remove the contact 324b from the tap 325_2 and connect the contact 324b to the tap 325_1. In preparation for removing the contact 324b from the tap 325_2, the inverter 663 is activated and generates the AC current i_650 and the voltage V 650. The contact 324b is removed from the tap 325_2 after the current ib is eliminated or suppressed. Because no current or very little current is flowing in the contact 324b when the contact 324b is removed from the tap 325_2, little or no arcing occurs when the switching operation commences.

FIG. 7C shows the voltage regulation device 610 during the switching operation, after the contact 325b has been removed from the tap 325_2 but before the contact 325b has been connected to the tap 325_1. The network 650 continues to produce the voltage V_650 and the current i_650. The voltage V_650 is used to control the potential difference between the contact 324a and the contact 324b and/or the flux in the core 336 to mitigate in-rush currents that could otherwise occur when the contact 325b is connected to the tap 325_2. For example, the network 650 may provide a voltage V_650 that causes the potential difference between the contact 324a and 324b to be zero (or nearly zero) so that there is no potential difference between the contact 324b and the tap 325_1 when the contact 324b is connected to the tap 325_1.

FIG. 7D shows the voltage regulation device 610 just after the switching operation is completed and the contact 324b is connected to the tap 325_1. The inverter 663 continues to produce the current i_650, and the current in the contact 324b continues to be suppressed after making contact with the tap 325_1. FIG. 7E shows the voltage regulation device 610 in steady-state operation in a non-bridging position. The contacts 324a and 324b are connected to the tap 325_1. The inverter 663 is disabled, and the current i_650 is not produced. The contacts 324a and 324b share the conduction of the load current.

Thus, the inverter 663 is activated to generate the voltage V_650 and corresponding current i_650 prior to a switching operation to reduce or eliminate arcing that would otherwise occur when a contact separates from a tap.

In some implementations, the voltage V_630 that suppresses the current ib is determined based on Equation (1) or Equation (2):

V_650=V_T−(V_337a+V__337b)+f(R, X, i_L) Equation (1)

V_650=(V_337a+V_337b)+f(R, X, i_L) Equation (2).

In Equations (1) and (2), V 337a and V_337b are, respectively, the voltage across the equalizer coils 337a, and V 337b, and f(R, X, i_L) is a function of circuit resistance (R), circuit reactance (X), and load current (i_L). Equation (1) provides the voltage (V_650) the inverter 663 produces to suppress the current ib for a bridging position (such as shown in FIG. 7A). Equation (2) provides the voltage (V_650) the inverter 663 produces to suppress the current ib for a non-bridging condition. The relationships shown in Equations (1) and (2) may be stored as executable instructions (for example, as a function or computer software) on the electronic storage 262 of the controller 260 such that the controller 260 is configured to determine V_650. The controller 260 may provide the value of V_650 to the network 650 such that the network 650 compensates for ib as discussed above. Equation (1) and (2) are examples, and other implementations are possible.

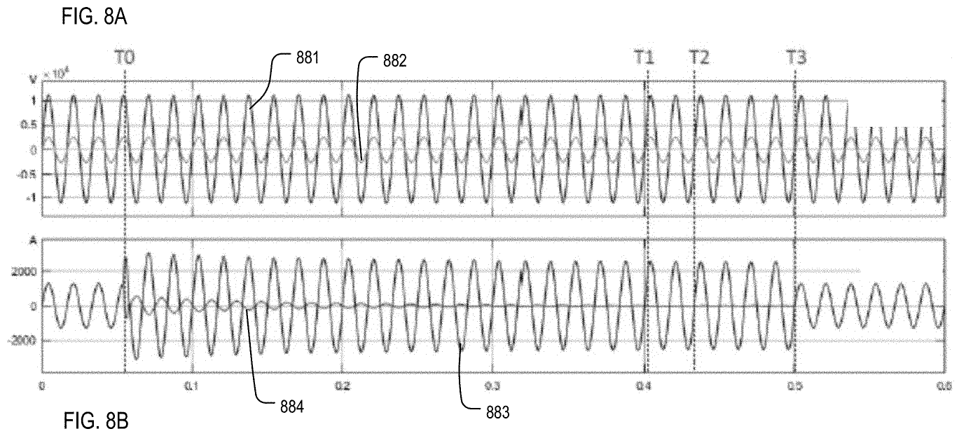

FIGS. 8A and 8B show simulated results for a switching operation performed by the voltage regulation device 610. To generate the data shown in FIGS. 8A and 8B, the contact 324b was moved in the manner illustrated in FIGS. 7A-7E. That is, the contact 324b was moved from the tap 325_2 to the tap 325_1. The contact 324a was connected to the tap 325_1 and was not moved. The voltage between any two adjacent taps (V_T) was 96V.

FIG. 8A includes a plot 881 and a plot 882. The plot 881 is the simulated voltage in volts (V) at the load 103 (FIG. 6A) as a function of time. The plot 882 is the simulated load current (i_L) as a function of time. Although the units of the y-axis in FIG. 8A are volts, it is apparent that the AC load current (i_L) and the AC voltage provided to the load 103 remain essentially constant over time despite the switching operation.

FIG. 8B includes plots 883 and 884. The plot 883 represents the current in the contact 324a as a function of time. The plot 884 represents the current in the contact 324b as a function of time. The time axis (the x axis) is the same in FIG. 8A and FIG. 8B.

Prior to the time T0, the contact 324a is connected to the tap 325_1 and the contact 324b is connected to the tap 325_2. Half of the load current (i_L) flows in each contact 324a and 324b, At time T0, the inverter 663 is activated (and the voltage V_650 and current i_650 are produced) by the network 650 while the contact 324b is connected to the tap 325_2. As shown in FIG. 8B, the magnitude of the current flowing in the contact 324b (plot 884) is reduced by the voltage and current injected by the inverter 663, and the current flowing in the contact 324b becomes approximately zero before the time T1. Between the time T0 and the time T1, the current flowing in the contact 324a (plot 883) increases to the load current i_L because all of the load current i_L is flowing in the contact 324a.

Between the times T1 and T2, the contact 324b is disconnected from the tap 325_2 and connected to the tap 325_1. Because there is no current flowing in the contact 324b, arcing does not occur when the contact 324b is separated from the tap 325_2. After the time T2, the contacts 324a and 324b are in a non-bridging position. The inverter 663 is still activated, and the current in the contact 324b may be suppressed to zero. At time T3, the inverter 663 is deactivated or disabled, and both contacts 324a and 324b each conduct the half of the load current plus the circulating current. Thus, after the time T3, the plots 883 and 884 are substantially the same (as they were at the time prior to the time T0).

For the scenario used to generate the simulated data shown in FIGS. 8A and 8B, the configuration and topology of the voltage regulation device 610 results in a circulating current that is zero or nearly zero such that ia is approximately equal to ib in magnitude and phase.

However, in other implementations, the circulating current would be larger, and there may also be a different load power factor such that ia and ib have different magnitudes and/or phases.

The implementations provided above are examples. Other implementations are within the scope of the claims. For example, the voltage between each tap V_T is consistent from tap to tap in the examples described above because the number of winding turns between each tap are consistent. In other implementations there may be a different number of turns between taps. The concepts for controlling magnetic flux in core 336 to avoid in-rush and transient current still apply. The controller 260 in FIG. 2 may be programmed with data for the main winding 220 (such as the number of turns between the various taps 225) and the equalizer 237 such that the network 250 is managed to accurately control the magnetic flux in core 236 for the variety of scenarios encountered when a tap change operation is made. For example, such information may be stored on the electronic storage 262 of the controller 260, may be transferred from another device or system, or may be entered into the controller 260 by an operator via the 1/0 interface 263.

What is claimed is:

1. A voltage regulation device comprising:
a plurality of taps;
a first electrical contact configured to connect to one of the plurality of taps;
a second electrical contact configured to connect to one of the plurality of taps; and
a network electrically connected to the first electrical contact and to the second electrical contact, wherein the network is configured to control a voltage differential between the first electrical contact and the second electrical contact or an amount of current that flows in the first electrical contact and the second electrical contact.

2. The voltage regulation device of claim 1, wherein the network is configured to control an impedance of a current path between the first electrical contact and the second electrical contact.

3. The voltage regulation device of claim 1, wherein the network is configured to control the voltage differential between the first electrical contact and the second electrical contact to be substantially the same as a voltage differential between a first one of the plurality of taps connected to the first electrical contact and a second one of the plurality of taps prior to connecting the second electrical contact to the second one of the plurality of taps.

4. The voltage regulation device of claim 1, wherein the network is configured to control the voltage differential between the first electrical contact and the second electrical contact to be zero volts (V) prior to removing the first electrical contact or the second electrical contact from one of the plurality of taps.

5. The voltage regulation device of claim 1, wherein the network is configured to provide a low impedance circuit current path between the first electrical contact and the second electrical contact prior to removing the first electrical contact or the second electrical contact from one of the plurality of taps.

6. The voltage regulation device of claim 1, further comprising a preventive autotransformer, and wherein the network is in parallel with the preventive autotransformer.

7. The voltage regulation device of claim 6, wherein the network is configured to reduce or prevent magnetic saturation of a magnetic core of the preventive autotransformer.

8. The voltage regulation device of claim 7, further comprising a controller, the controller configured to access one or more design parameters of the voltage regulation device, and wherein the controller is configured to control the network based on the one or more design parameters.

9. The voltage regulation device of claim 8, wherein the controller is configured to access the one or more design parameters from an electronic storage of the controller.

10. The voltage regulation device of claim 1, wherein the network comprises:
a rectifier configured to convert alternating current (AC) electrical power to direct current (DC) electrical power;
an inverter configured to convert DC electrical power to AC electrical power; and
a DC link electrically connected to the rectifier and the inverter, and wherein the network being electrically connected to the first electrical contact and the second electrical contact comprises the inverter being electrically connected to the first electrical contact and the second electrical contact.

11. The voltage regulation device of claim 10, wherein the network is configured to control a voltage differential between the first electrical contact and the second electrical contact by generating a voltage.

12. The voltage regulation device of claim 10, wherein the network is configured to control a current in the first electrical contact or the second electrical contact by injecting a current that flows in the first electrical contact or the second electrical contact.

13. The voltage regulation device of claim 1, wherein the network comprises a multi-position switch and a winding, wherein the winding is configured to be magnetically coupled to an AC power source.

14. The voltage regulation device of claim 1, wherein the network does not include a coil configured to be magnetically coupled to an AC power source.

15. The voltage regulation device of claim 1, further comprising:
a first coil;
a second coil; and
a magnetic core configured to magnetically couple the first coil and the second coil, wherein the network is electrically connected to the first coil and the second coil, and the network is configured to reduce or prevent magnetic saturation of the magnetic core.

16. An apparatus for a voltage regulation device, the apparatus comprising:
a network comprising at least one electrical element, the network configured to electrically connect in parallel with a preventive autotransformer of the voltage regulation device and to electrically connect to a first electrical contact of the voltage regulation device and to a second electrical contact of the voltage regulation device, wherein
the network is configured to control a current in one or more of the first electrical contact and the second electrical contact or to control a voltage difference between the first electrical contact and the second electrical contact.

17. The apparatus of claim 16, wherein the network is configured to electrically connect directly to the first electrical contact of the voltage regulation device and directly to the second electrical contact of the voltage regulation device.

18. The apparatus of claim 16, wherein the network is configured to reduce or prevent magnetic saturation of the magnetic core of the preventive autotransformer.

19. The apparatus of claim 16, wherein the apparatus is coupled to a controller configured to access one or more design parameters of the voltage regulation device, and the controller is configured to control the network based on the one or more design parameters.
